(19) United States
(12) Patent Application Publication
(10) Pub. No.: US 2020/0375202 A1
(43) Pub. Date: Dec. 3, 2020

(54) HIGH VISCOSITY BRINE FOR WHOLE POULTRY

(71) Applicant: John Bean Technologies Corporation, Chicago, IL (US)

(72) Inventor: Dale Robert Hunt, Valparaiso, FL (US)

(73) Assignee: John Bean Technologies Corporation, Chicago, IL (US)

(21) Appl. No.: 16/887,075

(22) Filed: May 29, 2020

Related U.S. Application Data
(60) Provisional application No. 62/855,578, filed on May 31, 2019.

(51) Int. Cl. A22C 9/00; A23L 13/70; A23L 13/40; A23B 4/28

(52) U.S. Cl. CPC A22C 9/001; A23B 4/285; A23L 13/428; A23L 13/72

(57) ABSTRACT

A brine for injecting into whole poultry is composed of substrate poultry meat which has been emulsified. The substrate poultry meat may consist of white meat, dark meat, or a combination of white meat and dark meat in proportion to their natural occurrence in the poultry. The poultry substrate for the brine may also include fat and skin from the poultry, optionally in proportion to their presence in the poultry. The emulsified brine composed of poultry substrate components is injected into whole poultry birds utilizing unique injection needles wherein the inlet side ports of the hollow needles are beveled or flared or curved or rounded. Such beveling or flaring or rounding or curving extends outwardly in the direction of the inlet port extending outwardly from the hollow interior of the needle.

### CROSS-REFERENCE TO RELATED APPLICATION

This application claims the benefit of U.S. Provisional Application No. 62/855578, filed May 31, 2019, the entire contents of which are incorporated herein by reference.

### BACKGROUND

Brines are commonly injected into poultry to help in maintaining the moisture and flavor of the poultry meat after completion of cooking or other preparation. The brine may include flavorings such as salt, oil, juices and various spices. A challenge in utilizing injected brines in poultry is retention of the brine within the poultry after injection and during cooking or even before cooking if there is a delay between injection and cooking. The effect of the brine is lost if not retained within the poultry. To this end, salt, starches, and binders such as gelatins and polysaccharides have been added to brines to aid in retention within the poultry. However, consumers are desirous of lower sodium meat products as well as meat products that have fewer or no “artificial” ingredients. The present disclosure seeks to address this desire of consumers.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Whole poultry is treated by injection of an emulsified brine composed of poultry substrate that constitutes from about 2 to 5% of the weight of the poultry. The poultry substrate is emulsified with water and optionally also ice. One or more additional components of the emulsified brine may consist of salt and flavorings. The poultry may include, for example, chicken, turkey, duck, goose, capon, game hens, quail, and pheas ant.

The poultry substrate component of the brine may consist of dark meat, white meat or a combination of dark meat and white meat.

The combination of dark meat and white meat may be in proportion to the relative weight of the white meat and dark meat naturally occurring in the poultry bird

The poultry substrate may also include the fat and/or skin of the poultry.

The fat and skin may be provided in proportion to the fat and skin naturally occurring in the poultry.

The brine may be injected into the poultry in an amount of about 1.5 to 25% of the weight of the poultry. Of this brine, about 60 to 70% by weight may consist of water and ice.

The brine may optionally also consist of salt of from 1.5 to 10% by weight of the brine.

The brine optionally may include flavorings, seasonings, spices and/or juices, which may consist of from about 0.1 to 20% of the weight of the brine.

The optional flavoring, seasoning, spices and/or juices may consist of one or more of sugar, pepper, garlic, parsley, thyme, mulling spices, chamushka, coriander, cinnamon, fennel, mustard, old spice, ginger, Bengal bay, cumin, blade mace, cardamom, chili(s), lemon, mint, bay leaf, anise, lime, orange, pomegranate, molasses, curry, ajowan, cloves, honey, and vinegar, yogurt.

The brine may optionally include a preservative used in quantities of about 0.2% to 0.5% of the brine by weight. Such preservatives may include, for example, sodium erythorbate, sodium lactate, sodium diacetate, and dried vinegar.

The temperature of the brine when injected into the whole poultry should be no higher than the temperature of the poultry bird itself. The typical temperature range for the brine may be from about 25° F. to 32° F.

The brine may be injected into the whole poultry at an amount of from about 15% to 25% of the weight of the whole poultry that has been butchered. More specifically the brine may be injected in an amount of from 17% to 22% of the weight of the butchered poultry.

The brine prepared in accordance with the present discloses may be injected to whole poultry by use of hollow injection needles. The needles may be mounted to a needle carrier so that a plurality of needles are inserted into the whole poultry at the same time. The hollow needles project from the needle carrier to a distal tip for delivering the brine into the whole poultry.

The brine is received into the needle by an inlet port located at the proximal or inlet end of the needle. Such port is in registry with a brine supply chamber within the needle carrier.

The inlet port of the brine injection needle may be elongated in cross section along the length of the needle. The inlet port is beveled or rounded or curved outwardly in the direction that the inlet port extends outwardly from the interior of the hollow needle.

If beveled, the angle of the bevel may be from 15 to 60°.

A specific angle of the bevel may be 45°.

If the inlet port is rounded or curved the radius of the curvature may be at least 1/2 the thickness of the wall section of the needle.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a needle carrier used to carry the brine injection needles of the present disclosure;

FIG. 2 is an enlarged fragmentary view of FIG. 1; and

FIGS. 3A and 3B are cross-sectional views of FIG. 2.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description and in the accompanying drawings, corresponding systems, assemblies, apparatus and units may be identified by the same part number, but with an alpha suffix. The descriptions of the parts/components of such systems assemblies, apparatus, and units that are the same or similar are not repeated so as to avoid redundancy in the present application.

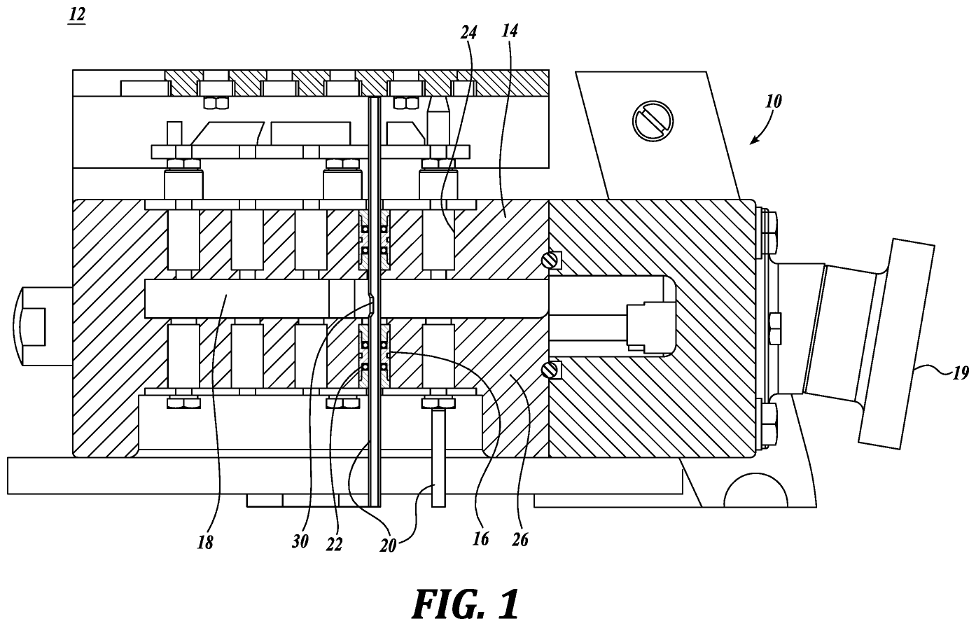

FIG. 1 illustrates a needle carrier 10 of a brining machine 12. The needle carrier includes carrier upper section 14 and a carrier lower section 16 to define a feeder supply chamber 18 therebetween. An inlet port 19 connects the supply chamber 18 to a source of brine.

Brine injection needles 20 are supported by the carrier 10. In this regard, seal rings 22 are disposed within counter bores 24 and 26 extending downwardly into the carrier upper section 14 and upwardly into the carrier lower section 16. The seal rings 22 are retained within the counter bores 24 and 26 to closely receive needles 20.

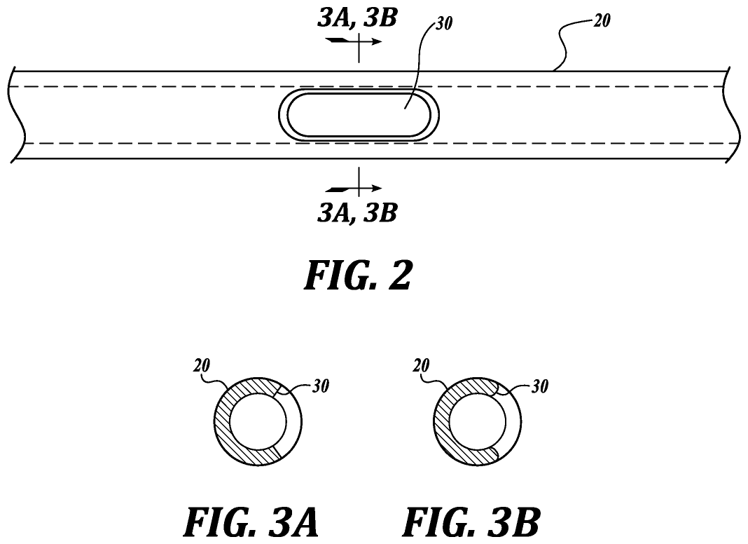

Inlet openings 30 are formed in the injector needles 20 so as to be in registry with the supply chamber 18. As shown in FIG. 2, the inlet opening is elongated along the length of the needle 20. Moreover, as shown in FIG. 3A, the inlet opening is beveled outwardly and inward in the direction extending outwardly from the interior of the hollow needle 20, the bevel angle can be of various designs, for example, from about 30° to 60°. As a further example, the bevel angle can be about 45°.

As another example, the inlet opening can be curved or radiused rather than in the form of a bevel, see FIG. 3B. The curvature may extend across the entire wall thickness of the entrance opening 30.

By tapering, beveling or curving, the inlet opening 30, components of liquids being injected by machine 12, including brines, have less tendency to build up at the inlet opening 30. If the inlet opening 30 is not beveled or tapered or curved, components of typical brines, especially solid material or fat or gelatinous material will tend to build up at the inlet opening 30 including at the corner of the opening with the extension of the hollow injection needle. Over time, buildup of such material can significantly reduce the size of the inlet opening or even cause the inlet opening to close all together. However, applicant has found that by beveling or curving the inlet opening 30 as shown in FIGS. 2, 3A, and 3B and as described above, there is less likelihood that brine materials will collect or build up at the inlet opening 30.

The brine of the present disclosure can be of numerous compositions, with the common component of the brine composed of emulsified substrate of the poultry being brined. This substrate is composed of the meat of the poultry and optionally also the fat and skin of the poultry. Water is used to form the brine emulsion.

Other components of the brine may include salt, flavorings, salt water, ice, phosphate, thickener(s), and preservative(s), though it is desirable to minimize or eliminate the use of “artificial” ingredients in the brine.

Poultry includes dark meat from the thigh and leg portions, as well as lighter white meat from the breast and wing portion of the poultry. The emulsified poultry substrate can consist of entirely white meat or entirely dark meat, or a combination of both. Applicant has discovered that composing the emulsified poultry substrate for the brine from a combination of dark meat and while meat provides a brine that not only helps retain the moisture from the brine within the poultry, but also provides a pleasing taste of the cooked poultry. Further, applicant has found that providing the dark meat and white meat in proportion to that naturally found in the poultry produces an optimum flavor as well as improved brine retention within the poultry both before cooking as well as after cooking.

Although the amount of dark meat and white meat in poultry may vary, applicant has found that for chicken, the percentage of dark meat may range from about 32 to 41% and the percentage of white meat may range from about 58 to 68%. The proportion of light and dark meat may vary by various factors including the type of poultry, the breed of poultry the conditions under which the poultry was raised, including the composition feed given to the poultry.

The white meat and dark meat may be composed of trimmings from the butchered/harvested poultry, which trimmings might otherwise not be as productively employed.

In addition to the emulsified brine being composed of light meat and dark meat, other components of the substrate may be used, including fat as well as skin from the poultry. The proportion of fat and/or skin in the brine may be selected so as to provide an emulsified poultry brine of a desired composition for optimal taste, brine retention within the poultry, etc. Applicant has found that utilizing fat and/or skin in proportion to that naturally occurring in the poultry provides a desirable poultry substrate component for the brine.

Although the amount of skin and fat in poultry may vary, applicant has found that for chicken, the percentage of skin and fat may range from about 7% to about 17% by weight of the butchered chicken. Of course, this percentage may vary by breed or type of chicken or even with chicken of the same breed. Also, this percentage may be different for different types of poultry.

The white meat, dark meat and optionally the fat and skin may be ground or otherwise reduced into relatively small pieces, for example, a maximum of 1/4 inch, and then combined with water to form an emulsion. Such emulsion may have an increased viscosity. Such viscosity may be measured using a Stein Hall viscosity cup. Using a Stein Hall viscosity cup, a calibrated amount of freshly prepared brine may take from 7 to 8 seconds to leave the cup. After a period of time, the brine thickens as the protein in the brine swells so that the same volume of brine may take from 19 to 20 seconds to empty from the Stein Hall viscosity cup. This increase in viscosity of the brine is believed to assist in retaining a high proportion of the brine in the whole poultry.

Applicant has found that the amount of the poultry substrate used in the brine can vary while providing improved brine retention relative to brines without poultry substrates therein. In this regard, applicant has found that utilizing poultry meat substrate in the amount of from about 2 to 5% of the weight of the poultry being treated provides the results being sought from the brine(s) disclosed in the present application. Of course, the composition of the poultry substrate may be beyond this range and still provide benefits including improved brine retention as well as pleasing flavoring or taste.

As noted above, the poultry substrate is mixed with water to form the brine emulsification. Water will comprise a significant proportion of the brine, typically from about 70 to 90% of the brine. The water may be softened or otherwise purified or treated, for example, by reverse osmosis. Part of the water may be provided in the form of ice to result in a brine temperature after emulsification that is below 32° F. Desirably, the temperature of the brine at the time of injection into the poultry substrate will be from about 24° to 32° F. It is desirable that the brine does not facilitate bacteria growth in the poultry between injection and prior to cooking the poultry. One way to address this will be to maintain the brine temperature below the temperature of the poultry being treated.

Salt can optionally be added to the brine to add or enhance flavoring and also assist in retention of the brine within the poultry substrate. The salt can be of various percentages, for example, from as low as about 0.1% to about 1% by weight of the final food product. Applicant has found that with the use of poultry substrate in the brine, less salt is required as a flavoring agent or for the retention of the brine in the poultry bird.

Various flavorings, including, for example, seasonings, spices and juices, may be utilized in the brine so as to achieve a desired taste or flavor for the poultry. The flavoring can make up from about 1% to 25% of the brine by weight. Many different flavorings, spices, seasonings and juices can be used. The following are some examples: sugar, pepper, garlic (dehydrated, minced, fresh), parsley, thyme, mulling spices, chamushka (seeds), coriander (seeds), cinnamon, fennel (seeds), mustard (ground, seeds, etc.), old spice (berries), ginger (with or without the skin), Bengal bay, cumin (seeds), blade mace, cardamom (seeds), chilis, lemon (peel or juice), mint, bay leaf, anise (seeds), lime (peel or juice), orange (peel or juice), pomegranate, molasses, curry, ajowan (seeds), cloves, honey, vinegar, yogurt, etc. The foregoing listing is not meant to be inclusive or limiting. Also, the spices and herbs and other flavorings can be fresh or dehydrated.

A thickener may optionally be added to the brine. One type of possible thickener is a hydrocolloid such as gelatin, agar or starch, such as rice starch. The thickening agent may be used in an amount from about 1 to 4% by weight of the brine. Of course, an amount of the thickening agent beyond this range may also be utilized.

Applicant has found that use of poultry substrate in the brine can reduce or even eliminate the need for a thickening agent in the brine.

The brine may also optionally utilize a preservative or antioxidant. One example is sodium erythorbate. This compound serves as a preservative, but also assists in flavor stability of the poultry. Other preservatives, for example, sodium lactate, sodium diacetate, dried vinegar, may be used in place of sodium erythorbate. Sodium erythorbate may be employed in the brine in quantities of from about 0.2% to 0.5% of the brine by weight.

Various amounts of brine as prepared using the present disclosure may be injected into whole poultry. The quantity of brine may from about 15% to 25% of the weight of the whole poultry. More specifically the brine may be from about 17% to 22% of the weight of the poultry. Applicant has found that brine of the compositions in the present disclosure utilizing substrate meat and also optionally skin and fat, injected into whole poultry is retained in the cooked poultry to a greater degree than brine without substrate components.

### EXAMPLE 1

Testing was performed with respect to adding substrate chicken poultry meat in a commercial brine to ascertain its effect in retention of the brine in the chicken poultry, both before and after cooking of the poultry.

### Brine Compositions

For the test, four compositions of brine were used as set forth in the Tables 1-4 below: (1) a commercial clear brine formulation; (2) the brine of sample 1 with the addition of dark substrate meat; (3) the brine of sample 1 with the addition of white substrate meat; and (4) the brine of sample 1 with the addition of white and dark substrate meat in proportion to that naturally occurring in the poultry carcass. In this regard, tests were carried out to determine the natural proportion of white and dark substrate meat in chicken carcasses. The investigation determined that chicken carcasses are about 37% dark meat and 63% white meat, with the dark meat from the legs and thigh and the white meat from the breast and wings.

The use of white substrate meat and/or dark substrate meat significantly increases the viscosity of the brine. As such, in Tables 2, 3 and 4 below and elsewhere in this application, these brines are identified by the designation “HVB” This signifies high viscosity brine.

Brine Formulations

1. Clear Brine Formulation

TABLE 1
Clear Brine Formulation 15% Inject

| | % in | In | Lbs in |
|---|---|---|---|
| Ingredient | Marinade | Final | Marinade |
| Water | 87.04% | | 43.52 |
| Salt | 6.90% | 0.90 | 3.45 |
| Thickener | 1.92% | 0.25 | 0.96 |
| Starch | 3.83% | 0.50 | 1.92 |
| Preservative | 0.31% | 0.04 | 0.16 |
| Total | 100.00% | | 50.00 |

2. HVB Brine Formulation Dark Meat

TABLE 2
HVB Brine Formulation 19.1% Inject Dark Meat

| | % in | In | Lbs in |
|---|---|---|---|
| Ingredient | Marinade | Final | Marinade |
| Clear brine | 100% | | 80¹ |
| | | | ¹25% of the water |
| | | | consists of ice. |
| Thigh Trim | 23.00% | 3.00 | 18.40 |
| Total | 123.00% | | 98.40 |

3. HVB Brine Formulation White Meat

TABLE 3
HVB Brine Formulation 19.1% Inject White Meat

| | % in | In | Lbs in |
|---|---|---|---|
| Ingredient | Marinade | Final | Marinade |
| Clear brine | 100% | | 80¹ |
| | | | ¹25% of the water |
| | | | consists of ice. |
| Breast Trim | 23.00% | 3.00 | 18.40 |
| Total | 123.00% | | 98.40 |

4. HVB Brine Formulation Natural Pronortions

TABLE 4
HVB Brine Formulation 19.1% Inject Natural Proportions

| | % in | In | Lbs in |
|---|---|---|---|
| Ingredient | Marinade | Final | Marinade |
| Clear brine | 100% | | 80¹ |
| | | | ¹25% of the water |
| | | | consists of ice. |
| Thigh Trim | 8.48% | 3.00 | 6.78 |
| Breast Trim | 14.52% | | 11.62 |
| Total | 123.00% | | 98.40 |

### Brine Injection and Retention

The four brine formulations detailed above were injected into both white and dark meat poultry halves, as discussed blow. The chart next below indicates the temperature of the brine when injected into the poultry halves.

5. Brine Temperature Data

TABLE 5

| Test | Brine Temp |
|---|---|
| Clear Brine | 44° F. |
| Dark Meat HVB | 28° F. |
| White Meat HVB | 26° F. |
| Natural Proportion HVB | 26° F. |

The next two tables below, Tables 6 and 7, pertain to the injection of the above brine formulations into the poultry white meat halves. Table 6 below indicates the initial or “green” weight of the white meat poultry half that was injected. The next column indicates the weight of the poultry half after injection. The third column indicates the percentage of the weight of the poultry composed of the brine. The fourth column indicates the weight of the poultry after 24 hours and before cooking. The last column (far right) indicates the percent of retention of the brine in the poultry white meat after 24 hours. As indicated in the chart, the brine consisting of either dark substrate meat, white substrate meat, or a natural combination of dark and white substrate meat retained approximately twice the amount of brine as was retained when only clear brine was used.

Table 7 below indicates the percentage loss of weight of the injected weight of the poultry white meat half after 24 hours, as well as the total retention percentage. As shown in Table 7, the clear brine test had the greatest percentage loss of 5.45% over the 24 hour hold period. The brines utilizing white, dark and white and dark combination substrate meat exhibited 0.65%, 1.19%, and 1.53% loss, respectively.

When the retention percentage is divided by the percentage pump, this represents the percentage of the initial injection that was still within the product after the hold period (% retention divided by % pump=Total Retention %). The clear brine only had a total retention percentage of 68.64% after the hold time. However, the tests utilizing substrate meat in the brine resulted in 96.92% retention for the white substrate meat based brine, 94.18% for the natural proportion of white and dark substrate meat brine, and 92.69% retention of the brine composed of dark substrate meat brine. Therefore, the tests resulted in anywhere from 24.06% to 28.29% greater total retention as compared to use of clear brine.

6. Infection and Retention Data for White Meat Halves

TABLE 6

| | Green | Injected | % | 24 hr | % |
|---|---|---|---|---|---|
| Test | Wt | Wt | Pump | Wt | Retention |
| Clear Brine | 12.65 | 14.85 | 17.39% | 14.16 | 11.94% |
| Dark Meat HVB | 12.40 | 15.00 | 20.97% | 14.81 | 19.44% |
| White Meat HVB | 12.35 | 14.95 | 21.05% | 14.87 | 20.40% |
| Natural Proportion HVB | 13.40 | 16.15 | 20.52% | 15.99 | 19.33% |

7. Percentage loss and Total Retention Data for White Meat Halves

TABLE 7

| | | Total |
|---|---|---|
| | Percentage | Retention |
| Test | Loss | % |
| Clear Brine | 5.45% | 68.64% |
| Dark Meat HVB | 1.53% | 92.69% |
| White Meat HVB | 0.65% | 96.92% |
| Natural Proportion HVB | 1.19% | 94.18% |

Tables 8 and 9 below show the results of injecting the four types of brine into poultry dark meat halves.

8. Injection and Retention Data for Dark Meat Halves

TABLE 8

| | Green | Injected | % | 24 hr | % |
|---|---|---|---|---|---|
| Test | Wt | Wt | Pump | Wt | Retention |
| Clear Brine | 9.60 | 11.20 | 16.67% | 10.71 | 11.56% |
| Dark Meat HVB | 9.15 | 11.05 | 20.77% | 10.82 | 18.25% |
| White Meat HVB | 8.90 | 10.75 | 20.79% | 10.65 | 19.66% |
| Natural Proportion HVB | 9.35 | 11.30 | 20.86% | 11.10 | 18.72% |

9. Percentage Loss and Total Retention Data for Dark Meat Halves

TABLE 9

| | | Total |
|---|---|---|
| | Percentage | Retention |
| Test | Loss | % |
| Clear Brine | 5.10% | 69.38% |
| Dark Meat HVB | 2.51% | 87.89% |
| White Meat HVB | 1.12% | 94.59% |
| Natural Proportion HVB | 2.14% | 89.74% |

Table 9 indicates the percentage weight loss and total retention percentage of the brine when the brine samples were injected into the poultry dark meat halves. The clear brine test indicated a 5.10% loss in the weight from the injected weight of 11.2 pounds. The samples that included white substrate meat, natural combination of white and dark substrate meat, and dark substrate meat showed a lower loss from the total weight of the poultry half of 1.12%, 2.14%, and 2.5%.

The total retention percentage column shows that the clear brine sample had the lowest total retention percentage, which means that the clear brine had the least amount of brine carried over from the initial injection to when the retention weights were calculated. The clear brine total retention was 69.38% whereas the other tests had total retention percentages of 94.59%, 89.74%, and 87.89% for the white substrate meat, natural proportion of white and dark substrate meat, and dark substrate meat tests, respectively. As such, the tests utilizing brine from poultry substrate had between 18.52% and 25.22% greater total weight retention over the test where clear brine was utilized. The test results show that poultry substrate could be used to replace components in commercial brines, such as thickeners.

Tables 10 and 11 below show the results of brine retention after the poultry meat halves were cooked. Cooking occurred until the poultry meat halves reached cooked temperatures. Regarding the data from the cooked white meat halves shown in Table 10, the cooked yields were all similar, ranging from 76.06% to 77.55%. However, a difference occurred in the yield to green percentage, meaning the percentage end weight from the initial white meat halves before brining. In this regard, the clear brine test had the lowest yield to green percentage of 85.14%. The natural proportion of white and dark substrate meat test had a yield to green of 92.54% which was the highest percentage. The test utilizing dark substrate meat in the brine had a yield to green percent of 92.18% and the brine consisting of white substrate meat had a yield to green of 91.82%. Thus, the brine having a natural proportion of white to dark substrate meat had the greatest difference from the clear brine test of 7.40%, followed by the sample using brine from dark substrate meat with a 7.04% advantage over clear brine and the brine composed of white substrate meat having a 6.68% advantage over clear brine.

### Cook Data

10. Cook Data for White Meat Halves

TABLE 10

| | Cook | Yield to | Difference |
|---|---|---|---|
| Test | Yield | Green | from Clear |
| Clear Brine | 76.06% | 85.14% | |
| Dark Meat HVB | 77.18% | 92.18% | 7.04% |
| White Meat HVB | 76.26% | 91.82% | 6.68% |
| Natural Proportion HVB | 77.55% | 92.54% | 7.40% |

11. Cook Data for Dark Meat Halves

TABLE 11

| | Cook | Yield to | Difference |
|---|---|---|---|
| Test | Yield | Green | from Clear |
| Clear Brine | 79.48% | 88.67% | |
| Dark Meat HVB | 81.65% | 96.55% | 7.88% |
| White Meat HVB | 82.63% | 98.88% | 10.21% |
| Natural Proportion HVB | 82.70% | 98.18% | 9.52% |

Table 11 above shows the results of cooking yield when the poultry dark meat halves were treated with the four brines. The yields from all four tests were within a 3% range of each other. In this regard, the clear brine test had the lowest cook yield of 79.48%, whereas the brine composed of white and dark substrate meat in a natural proportion had the greatest yield of 82.70%.

A significant difference was, however, observed in the “Yield to Green” data. The clear brine test had the lowest yield to green of 88.67%. The brines utilizing substrate meat had yield to green percentages of 98.88%, 98.18%, and 96.53% for brines composed of white substrate meat, white and dark substrate meat in natural proportions, and dark substrate meat, respectively. The results show an advantage of use of the white substrate meat brine over the clear brine of 10.21%. The brine composed of a natural proportion of white and dark substrate meat had an advantage over the clear brine of 9.52%, and the brine composed of dark substrate meat had an advantage over clear brine of 7.88%. These percentages show that brine composed of substrate meat clearly provided the higher cook yield over the use of the clear brine formulation discussed above.

### EXAMPLE 2

Example 2 consists of a test carried out to inject brines of various compositions into whole chicken poultry birds. The different brine compositions are listed in Table A below. The whole poultry birds were injected with the brines. Thirty minutes thereafter, the percentage of the brine retained in the poultry birds was measured. Thereafter, the brined poultry birds were cooked to 185° F. and then the weights of the cooked poultry birds were measured for weight retention.

### Brine Compositions

TABLE A

| | Brine Composition |
|---|---|
| 1 | Clear Brine |
| 2 | HVB Brine-Clear brine with salt and trim in natural proportions |
| 3 | HVB Brine-Clear brine with salt and trim in natural proportions |
| | with skin and fat |
| 4 | HVB Brine-Unsalted brine with trim in natural proportions |
| | with skin and fat |

1. Clear Brine Solution

TABLE B

| | % in | % in |
|---|---|---|
| Ingredient | Marinade | Final |
| Water | 80.83% | |
| Salt | 3.83% | 0.50% |
| Seasoning | 15.33% | 2.00% |
| Total | 100.00% | |

The clear brine solution, set forth in Table B, is composed of 80.83% water, 3.83% salt, 15.33% seasoning. The salt constituted 0.5% of the brined weight of the poultry bird whereas the seasoning constituted 2% of the total weight of the brined poultry bird. The poultry bird was injected with the brine at a target level of 15% by weight.

2. HVB Brine

Clear brine with trim in natural proportions

TABLE C

| | % in | % in |
|---|---|---|
| Ingredient | Marinade | Final |
| Clear Brine | 64.64% | |
| Ice | 19.61% | |
| White Meat Trim | 9.95% | 1.89% |
| Dark Meat Trim | 5.81% | 1.11% |
| Total | 100.00% | |

Brine #2 used the clear brine #1 as set forth in Table B above, to which was added ice as well as a mixture of white and dark substrate meat in proportion to that naturally occurring in the poultry bird. The percentage composition of the brine is indicated in Table C above. The mixture was emulsified and the brine injected into the target in an amount of 19.1% by weight. The brined poultry bird was evaluated after 30 minutes for brine loss.

3. HVB Brine

Clear brine with trim in natural proportion, plus skin and fat

TABLE D

| | % in | % in |
|---|---|---|
| Ingredient | Marinade | Final |
| Clear Brine | 64.64% | |
| Ice | 19.61% | |
| White Meat Trim | 8.14% | 1.55% |
| Dark Meat Trim | 4.73% | 0.90% |
| Skin and Fat | 2.89% | 0.55% |
| Total | 100.00% | |

Brine #3 used the brine from composition #2 to which was added substrate skin and fat. The percentage of the composition of the brine is listed in Table D. Brine #3 was injected into the poultry bird at a percentage of 19.1% by weight. Thirty minutes later, the poultry birds were weighed for brine loss.

4. HVB Solution

Unsalted Brine and Trim in Natural proportions, Plus Skin and Fat

TABLE E

| | % in | % in |
|---|---|---|
| Ingredient | Marinade | Final |
| Water | 42.12% | |
| Unsalted Brine | 21.06% | |
| Ice | 21.06% | |
| White Meat Trim | 8.14% | 1.55% |
| Dark Meat Trim | 4.75% | 0.90% |
| Skin and Fat | 2.87% | 0.55% |
| Total | 100.00% | |

This brine #4 utilized brine to which was added ice, dark substrate meat, white substrate meat, substrate skin and fat in the percentages indicated. The whole poultry birds were injected with this brine in an amount of 19.1% by weight. Thirty minutes thereafter, the brined poultry bird was measured for weight loss.

### Brine Injection and Results

Table F below sets forth the green (original) weight of the poultry bird, the weight of the poultry bird after injection of the brine, and the percentage of the weight of the bird that the brine constituted.

TABLE F

| | Injection | Green | Injected | Injection |
|---|---|---|---|---|
| Test | Target | Wt | Wt | % |
| 1-Clear brine | 15.00% | 34.55 | 40.27 | 16.55% |
| 2-HVB Clear brine, natural proportions | 19.10% | 21.35 | 25.62 | 19.98% |
| 3-HVB Clear brine, natural proportions, | 19.10% | 20.94 | 25.44 | 21.49% |
| skin and fat | | | | |
| 4-HVB Unsalted brine, natural | 19.10% | 34.19 | 41.13 | 20.30% |
| proportions, skin and fat | | | | |

As set forth in Table G below, after 30 minutes the poultry bird injected with clear brine had a weight of 39.36 ounces. There was no appreciable weight loss in the poultry birds injected with brine #s 2 and 3. The poultry bird injected with brine #4 consisting of unsalted brine but with a natural proportion of white and dark substrate meat, skin and fat had a weight of 39.86 ounces down from an injected weight of 41.13 ounces. As indicated in Table G, clear brine #1 and brine without salt, #4, showed weight loss after 30 minutes after injection, but the brines with a natural proportion of whole and dark substrate meat and substrate fat and skin, #s 2 and 3, showed no appreciable loss of weight after 30 minutes.

TABLE G

| | Wt after | % |
|---|---|---|
| Test | 30 min | Retention |
| 1-Clear brine | 39.36 | 13.92% |
| 2-HVB Clear brine, natural proportions | No noticeable purge was seen | |
| 3-HVB Clear brine, natural proportions, | No noticeable purge was seen | |
| skin and fat | | |
| 4-HVB Unsalted brine, natural | 39.86 | 16.58% |
| proportions, skin and fat | | |

### Cook Data

Table H below shows the results after cooking the poultry bird to a temperature of 185° F. In Table H, the column entitled “cook yield” showed that the yield from the weight of the poultry using brine #1 was 65.24%. The yields from the brines ##2, 3 and 4 were somewhat higher at 66.67%, 68.95%, and 67.01%. The difference in yield from the original weight (green) showed more variation. In this regard, the far right column of Table H indicates the yields for the four listed brines were 74.32%, 79.99%, 83.77%, and 78.12%. The brines that utilized substrate from the poultry birds, whether meat alone as shown in brine #2, or with the addition of skin and fat as in brine #s 3 and 4, resulted in a clear increase in yield from the green weight of the poultry bird, relative to use of clear brine (#1) which did not include any substrate content.

TABLE H

| | | | | | Cook |
|---|---|---|---|---|---|
| | Green | Injected | Cooked | Cook | Yield to |
| Test | Wt | Wt | Wt | Yield | Green |
| 1-Clear brine | 3.69 | 4.20 | 2.74 | 65.24% | 74.32% |
| 2-HVB Clear brine, natural proportions | 3.20 | 3.84 | 2.56 | 66.67% | 79.99% |
| 3-HVB Clear brine, natural proportions, | 3.61 | 4.38 | 3.02 | 68.95% | 83.77% |
| skin and fat | | | | | |
| 4-HVB Unsalted brine, natural | 4.21 | 4.91 | 3.29 | 67.01% | 78.12% |
| proportions, skin and fat | | | | | |

### EXAMPLE 3

Example 3 provides a brine formulation as set forth in the table below.

HVB WOG Natural Proportion Formulation

| | |
|---|---|
| Water | 56.301% |
| Ice | 18.767% |
| Salt | 4.675% |
| Flavorings | 1.558% |
| White meat trim | 9.661% |
| Dark meat trim | 5.610% |
| Skin & Fat | 3.428% |
| Total | 100.00% |

The brine formulation above provides a basic brine formulation for insertion into whole poultry that might be cooked, for example, on a rotisserie or on a barbecue grill or roasted in an oven. The percentage of the substrate is higher than the brine formulation in Example 2.

As in the brine formulations discussed above, the brine of Example 3 is produced by chopping or otherwise reducing the meat trim, skin and fat into pieces that are no more than 1/4 inch in length. Thereafter, the brine ingredients are mixed together and then emulsified for injection into whole poultry.

### EXAMPLE 4

| | % in | % in |
|---|---|---|
| Ingredients | Final | Marinade |
| Water | | 69.39% |
| Salt | 1.09% | 6.71% |
| Rice Starch | 0.88% | 5.42% |
| Trim | | 18.48% |
| Total | | 100.00% |

### EXAMPLE 5

| | % in | % in |
|---|---|---|
| Ingredients | Final | Marinade |
| Water | | 68.66^{∧} |
| Salt | 1.09% | 6.87% |
| Rice Starch | 0.88% | 5.55% |
| Trim | | 18.92% |
| Total | | 100.00% |

### EXAMPLE 6

| | % in | % in |
|---|---|---|
| Ingredients | Final | Marinade |
| Water | | 74.81% |
| Salt | 1.09% | 6.71% |
| Trim | | 18.48% |
| Total | | 100.00% |

Examples 4, 5 and 6 above provide additional brine formulations as part of the present disclosure. In Examples 4 and 5, rice starch is used as a thickener. The rice starch has been deleted from Example 6. The trim is composed of white and dark meat in proportion to that naturally occurring in the poultry substrate. The brine is prepared in the same manner as described above.

### EXAMPLE 7

In this example, the brine formulation contains the following herbs: garlic (shell removed), ginger (skin removed), chili peppers (stalk removed), cilantro (added as is).

The herbs would be added to the emulsifier along with the brine and meat trimmings. The pre-breaker would be used to reduce the particles size to approximately 1 mm (approximately 15 seconds pre-break). The emulsifier knife and plate would then be used to emulsify (for 2 to 3 minutes, for example) into a homogenous injectable solution.

While illustrative embodiments have been illustrated and described, it will be appreciated that various changes can be made therein without departing from the spirit and scope of the invention.

The embodiments of the invention in which an exclusive property or privilege is claimed are defined as follows:

1. An injection needle for devices for injecting a liquid into meat food products having a needle carrier for supporting the needle during use and a liquid feed chamber for supplying the liquid to the needle, the needle comprising a hollow needle body, comprising:
a distal tip for delivering the liquid into the meat food products;
a proximal inlet end portion for receiving the liquid into the needle;
at least one inlet port extending through the proximal inlet end portion of the needle and registrable with the feed chamber, the inlet port beveled or curved outwardly in the direction that the inlet end portion extends outwardly from the interior of the hollow needle.

2. The injection needle according to claim 1, wherein the inlet port extends through the side wall of the proximal inlet end portion of the needle.

3. The injection needle according to claim 2, wherein the inlet port is elongated in cross section.

4. The injection needle according to claim 3, wherein the elongated direction of the inlet port extends along the length of the needle.

5. A brine for treating a whole poultry by injection of the brine into the whole poultry, the brine comprising:
water;
emulsified poultry substrate composed of poultry meat, the emulsified poultry substrate ranging from about 2 to 5% of the weight of the poultry bird being treated; and
optionally one or more components selected from the group consisting of salt, salt water, flavorings, and ice.

6. The brine according to claim 5, wherein the emulsified poultry substrate is composed of at least one of: dark meat; white meat; and a combination of dark meat and white meat.

7. The brine according to claim 5, wherein the emulsified poultry substrate is composed of white meat and dark meat generally in proportion to the relative weight of the white meat and dark meat naturally occurring in the poultry substrate.

8. The brine according to claim 7, wherein the emulsified poultry substrate is further composed of either or both fat and skin from the poultry substrate.

9. The brine according to claim 5, having a temperature when injected into the poultry of from about 25 to 32° F.

10. The brine according to claim 5, wherein water comprises from 60 to 70% of the brine by weight.

11. The brine according to claim 5, wherein the optional salt comprises from 0.1 to 1.0% by weight of the cooked poultry.

12. The brine according to claim 5, wherein the optional flavorings include one or more flavorings selected from the group consisting of sugar, pepper, garlic, thyme, parsley, mulling spices, chamushka, coriander, cinnamon, fennel, mustard, old spice, ginger, Bengal bay, cumin, blade mace, cardamom, chili(s), lemon, mint, bay leaf, anise, lime, orange, pomegranate, molasses, curry, ajowan, cloves, honey, vinegar, yogurt.

13. A method of treating a whole poultry, comprising:
providing an uncooked whole poultry; and
injecting the uncooked whole poultry with a brine comprising emulsified poultry substrate comprising poultry meat, the emulsified poultry substrate comprising from about 2 to 5% by weight of the poultry.

14. The method according to claim 13, wherein the emulsified poultry substrate is composed of at least one of: dark meat; white meat; and a combination of dark meat and white meat.

15. The method according to claim 13, wherein the emulsified poultry substrate is composed of white meat and dark meat generally in proportion to the relative weight of the white meat and dark meat naturally occurring in the poultry.

16. The method of claim 13, wherein the emulsified poultry substrate further includes fat and/or skin of the poultry.

17. The method of claim 13, wherein injecting the whole poultry with a brine comprises injecting brine in the amount of about 15 to 25% by weight of the poultry.

18. The method according to claim 13, wherein the brine comprises water in an amount from about 60 to 70% by weight of the brine.

19. The method according to claim 13, wherein the brine optionally comprises flavoring, seasoning, spice or juice.

20. The method according to claim 13, wherein the brine injected into the poultry bird is at a temperature of about 25 to 32° F.
